(19) United States
(12) Patent Application Publication
(10) Pub. No.: US 2008/0319998 A1
(43) Pub. Date: Dec. 25, 2008

(54) SYSTEM AND METHOD FOR DYNAMIC AUTHORIZATION TO DATABASE OBJECTS

(76) Inventor: Michael Bender, Rye Brook, NY (US)

Correspondence Address: HOFFMAN WARNICK LLC, 75 STATE ST, 14TH FLOOR, ALBANY, NY, 12207, US

(21) Appl. No.: 11/765,467

(22) Filed: Jun. 20, 2007

(51) Int. Cl. G06F 17/30

(52) U.S. Cl. 707/9; 707/E17.044

(57) ABSTRACT

The present invention provides a system and method allows a user to add a parameter at the end of the GRANT statement that would not require multiple changes by the DBA. The parameter may indicate that the user only needs to have access for 2 days, or to have access when a flag is set in the database. This reduces the frequency that a DBA needs to be engaged and decreases the cycle time that is necessary to turn the request around. An additional benefit is that the authority is removed when it should be. This then also improves the business controls around the data.

### FIELD OF THE INVENTION

The present invention relates generally to granting access to database systems and, more specifically, to improvements to systems and methods for dynamically granting authorization to database objects.

### BACKGROUND OF THE INVENTION

In the data warehousing space, there are frequently times when someone needs to gain temporary access to a database object. A data warehouse is the main repository of an organization's historical data, its corporate memory. An example is IBM's DB2® and can be seen here http://publib.boulder.ibm.com/infocenter/db2luw/v9/index.jsp. Currently, a user needs to be authenticated (authentication is the process of attempting to verify the digital identity of the sender of a communication such as a request to log in. (See http://www.authenticationworld.com/.) And then, engage a database administrator (DBA) (a person who is responsible for the environmental aspects of a database) to grant the access, and at the appropriate time, have the DBA revoke the access. A better solution would be to have the grant to the object be based dynamically on time or other objects in the database.

Today, the GRANT statement for a database is in the general format of Grant <requested authority> on <object> to <id/group>. This form of the GRANT statement grants privileges on a package. This statement can be embedded in an application program or issued through the use of dynamic SQL statements. It is an executable statement that can be dynamically prepared only if DYNAMICRULES run behavior is in effect for the package (SQLSTATE 42509). The privileges held by the authorization ID of the statement must include at least one of the following:
CONTROL privilege on the referenced package
The WITH GRANT OPTION for each identified privilege on package-name
SYSADM or DBA authority

SYSADM or DBA authority is required to grant the CONTROL privilege.

This is a problem as an authority, such as a DBA, is required to grant or to not grant privileges. This causes latency in database access requests. Unfortunately, sometimes, temporary authority is granted, but then someone forgets to request that the authority be removed.

Some systems allow the ability to grant access to a database, such as through the use of time based access authorization, to an access requestor such as obtaining access, or authorization, through an Internet server utilizing the WHOIS infrastructure. (WHOIS is a TCP-based query/response protocol which is widely used for querying a database in order to determine the owner of a domain name, an IP address, or an autonomous system number on the Internet.) WHOIS lookups are generally utilized using simplified web-based tools to look up domain ownership details from different databases. For more information, see http://tools.ietf.org/html/rfc3912.) However, these systems are not geared towards authenticating access to database objects with different levels of predefined rules.

There is a need for dynamically granting authorization to database objects.

### BRIEF SUMMARY OF THE INVENTION

The present invention provides a system and method for dynamically granting authorization to database objects.

The present invention provides a system and method allows a user to add a parameter at the end of the GRANT statement that would not require multiple changes by the DBA. The parameter may indicate that the user only needs to have access for 2 days, or to have access when a flag is set in the database. This reduces the frequency that a DBA needs to be engaged and decreases the cycle time that is necessary to turn the request around. An additional benefit is that the authority is removed when it should be. This then also improves the business controls around the data.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a diagram which illustrates a basic database access system.

FIG. 2 illustrates the system of the present invention for the system and method of the present invention for dynamically granting authorization to database objects.

FIG. 3 illustrates the system of the present invention.

FIG. 4 illustrates the new GRANT statement of the present invention.

FIG. 5 illustrates a second embodiment of the new GRANT statement of the present invention.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method for dynamically granting authorization to database objects.

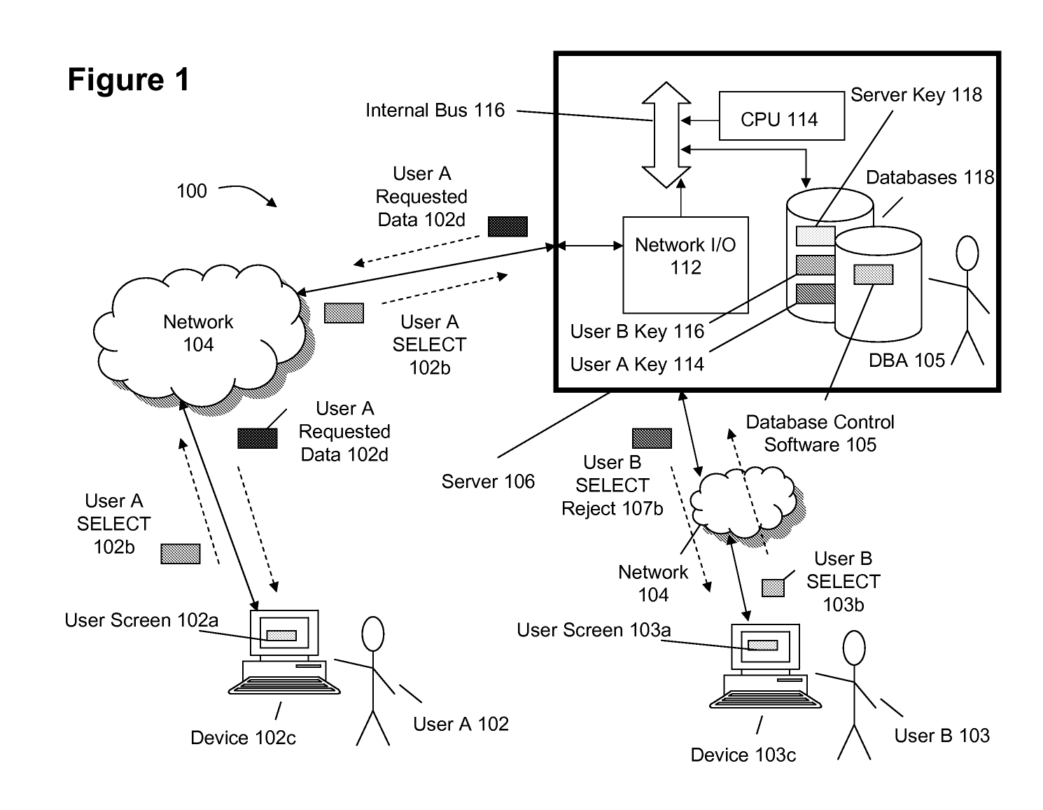

FIG. 1 illustrates a basic database access system. It comprises a User A 102 and a User B 103, both of whom have logged in using their respective user IDs, are requesting access to Databases 118 via Users' A, B 102, 103 SELECTs 102b, 103b. The SELECTs could be requests for data located within tables within Databases 118. User A 102 and User B 103 have communicating Devices 102c, 103c, such as personal computers, having screens 102a, 103a to illustrate messages from the Server 106. (However, the Devices 102c, 103c don't need to be personal computers as it can as easily be a cell phone, PDA and the like.) Like most, if not all, servers, Server 106 has a network input/output device 112 to receive and send messages, one or more CPUs 114, Databases 118 to store data, such as a data table, and an internal bus 114 like other computers. According to typical security procedures, User A has a Key 115, User B 116 has a key, and Server 106 has a Key 118 for authentication purposes. Both users use the keys and transmit other known information to log into the Databases 118.

The SELECT request, or other types of requests, is done using current state of the art processes for granting access to a relational database object. The processes are built into the relational database (e.g., IBM® DB2®—see http://publib.boulder.ibm.com/infocenter/db2luw/v9/index.jsp). The present invention allows for logic to determine on and off.

As can be seen, an access grant request, User A SELECT 102b, is sent to Server 106 via Network 104. A SELECT request asks for privileges on a package, or data object such as a data table, and a GRANT grants the requested privileges and the requested data is transmitted to the requesting user. A GRANT reject does not accept the request and the reject message is transmitted to the requesting user. The control statement is embedded within the database by a DBA. This statement can be embedded in an application program or issued through the use of dynamic SQL statements. It is an executable statement that can be dynamically prepared only if DYNAMICRULES run behavior is in effect for the package (SQLSTATE 42509). More information on this topic can be found at http://publib.boulder.ibm.com/infocenter/db2luw/v9/index.jsp.

The User A SELECT 102b is processed through the Network 104 and through the Server 106 and is processed by Database Control Software 105 and User A Requested Data 102d is sent to User A 102. User B 103 sends User B SELECT 103b through Network 104 and is processed but is rejected due to the fact that User B 103 is not authorized by DBA 105. The User B SELECT Reject 107b is sent through Network 104.

The DBA utilizes a GRANT statement to control access to the Databases 118. The GRANT statement exists today. An example of that statement would be: GRANT SELECT on table1 to User A

The GRANT SELECT Statement is issued by a DBA or authorized user (after he/she logs into the database management system (DBMS)) and grants access to table1 to User A 102. The authority to access to User A 102 to table1 is also logged in the DBMS.

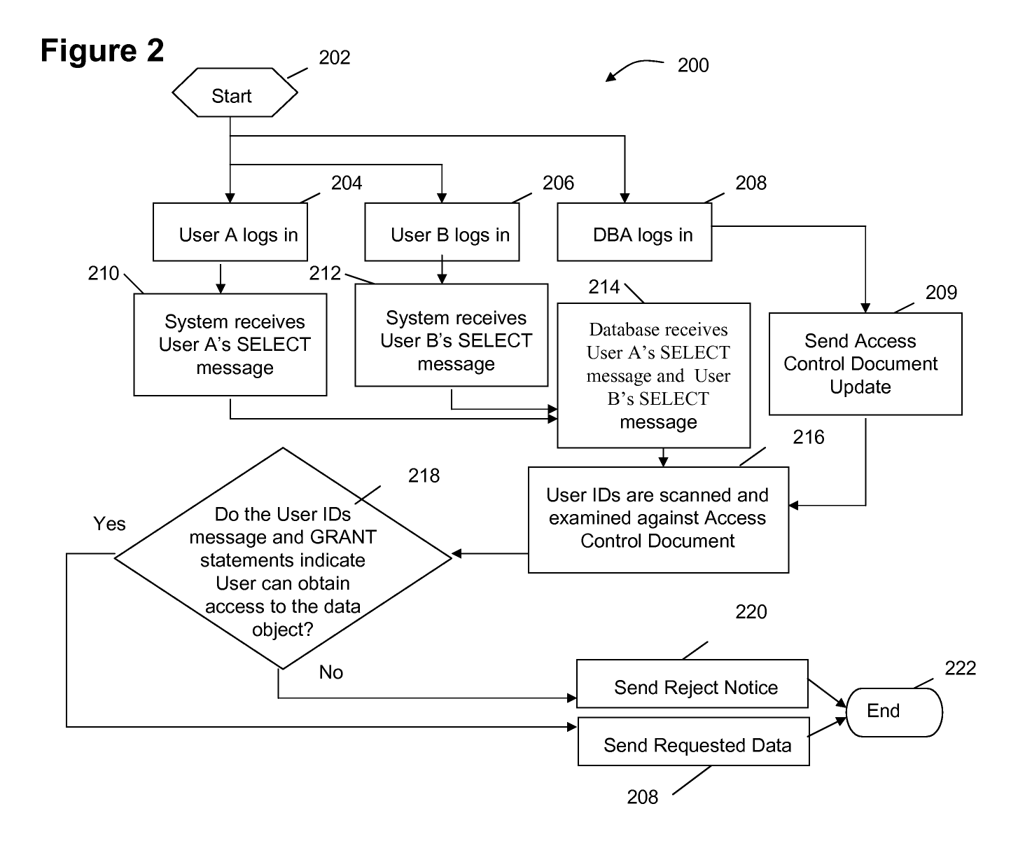

This is shown in FIG. 2 where the Process 200 of the present invention is shown. It starts at Step 202 and moves to Steps 204, 206, 208 where User A, User B and DBA log in. It should be noted that all of these parties can be located remotely. User A has User A ID, User B has User B ID, etc., and each has specific access rights. For instance, in FIG. 2, both User A and User B send SELECT statements at 210 and 212, such as a SELECT statement to a specific table in a database. Because User A has access to the selected database according to the GRANT statement, he gets the data he requested while User B does not have access according to the GRANT statement so he does not receive the access to the data. In addition, if the DBA issues a REVOKE command for a specific user to a specific database, the user will receive an error message.

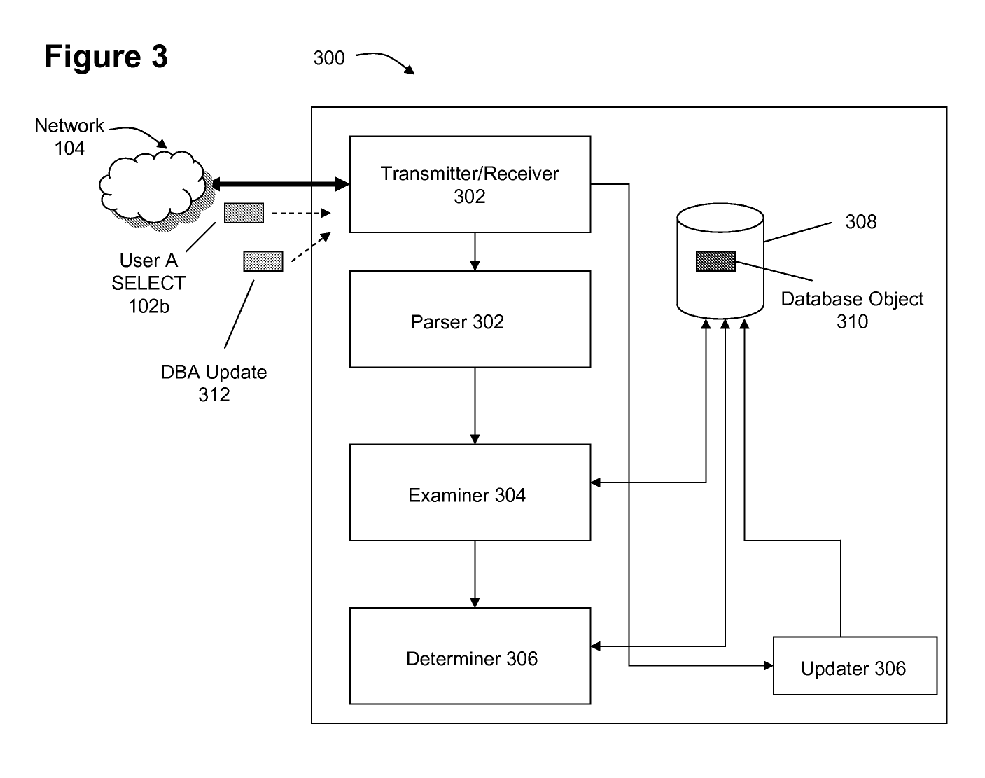

FIG. 3 illustrates the System 300 of the present invention which has a Transmitter/Receiver 302 for transmitting and receiving messages such as User A SELECT 102b message and DBA Update 312. System 300 further has a Parser 302 for parsing messages, such as the User A SELECT 102b message, and pulling user IDs from a previous log on. System 300 further has an Examiner 304 for examining the parsed message and corresponding user ID and a Determiner 306 for determining whether User A had the requested access by comparing the User A ID and the User A SELECT 102b message against the GRANT document of the Database Object 310 stored in Databases 308. The Updater 306 allows the DBA to update the GRANT document associated with the Database Object 310.

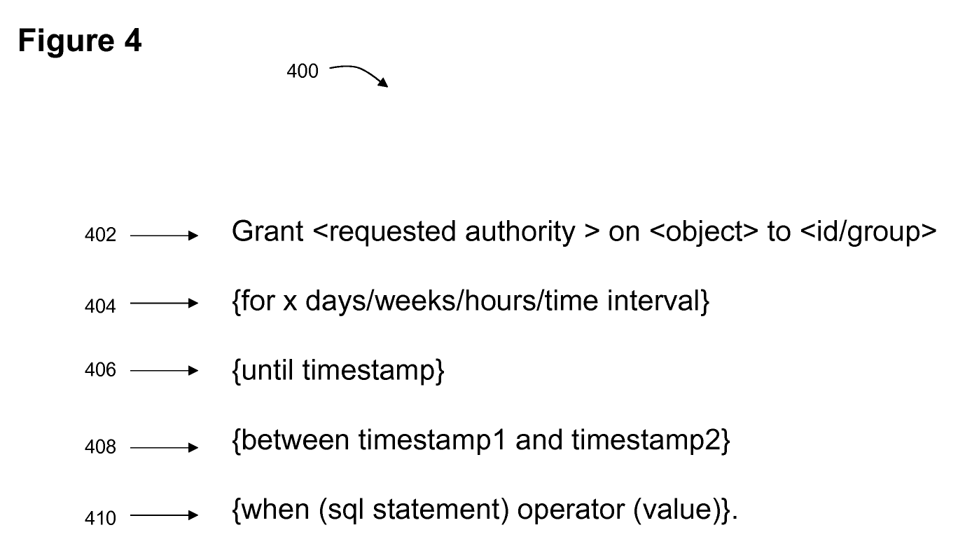

FIG. 4 illustrates the new GRANT statement 400 of the present invention. At 402, the GRANT statement 400 identifies the statement as a GRANT, the authority, the data object and the ID/group. Statement 404 identifies the time interval for which the GRANT statement 400 is viable. Statement 406 identifies the “until” timestamp or which the GRANT statement 400 is viable for Database Object 310 for ID/group. Statement 408 identifies the “between” time for which the GRANT statement 400 is viable. Statement 410 identifies the end of the SQL query.

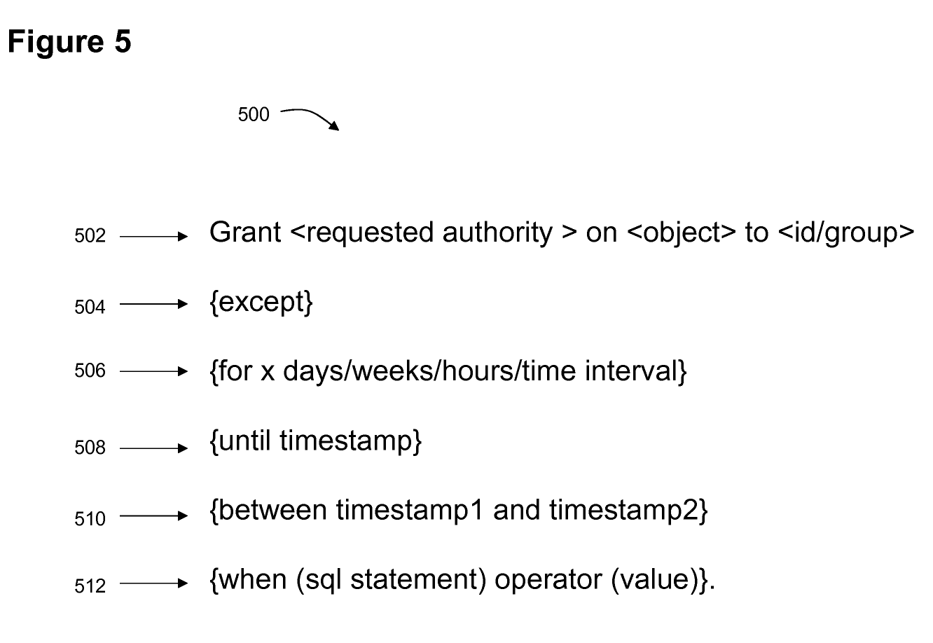

FIG. 5 illustrates a second illustrative embodiment of the new GRANT statement 500 of the present invention. At 502, the GRANT statement 500 identifies the statement as a GRANT, the authority, the data object and the ID/group. Statement 504 identifies the “except” time interval for which the GRANT statement 500 is not viable, the “except” time is by Statement 506 which identifies the “for” timestamp. Statement 508 identifies the “until” timestamp when the “except” statement expires. Statement 510 identifies the “between” time for which the “except” statement is active. Statement 512 identifies the end of the SQL query.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for granting access to a database object in a system, the system having an access control document for the database object, the access control document having access GRANT parameters for the database object, comprising the steps of:
a. receiving an access request from a user;
b. examining the access request against the access control document and GRANT parameters;
c. determining whether the user is allowed access to the database object according to security rules, the access control document and GRANT parameters;
d. if not, rejecting the access to the database object;
e. if so, granting access to the database object.

2. The method of claim 1 further including the steps of receiving the requesting user's ID and examining the requesting user's ID against the access control document and GRANT parameters to determine whether the requesting user can obtain access to the database object.

3. The method of claim 2 wherein the GRANT parameters include the timeframe in which the requesting user can obtain access to the database object.

4. The method of claim 3 wherein the GRANT parameters include timestamps.

5. The method of claim 2 wherein the GRANT parameters include the timeframe in which the requesting user cannot obtain access to the database object.

6. The method of claim 5 wherein the GRANT parameters include timestamps.

7. The method of claim 2 wherein the GRANT parameters are stored in a database table.

8. The method of claim 1 further including the step of a database administrator changing the GRANT parameters.

9. A computer program product in a computer readable medium for operating in a system comprising a network I/O, a CPU, and one or more databases, for implementing a method in a system for determining whether access should be granted to a database object in a system, the system having an access control document for the database object, the access control document having access GRANT parameters for the database object, comprising the steps of:
a. receiving an access request from a user;
b. examining the access request against the access control document and GRANT parameters;
c. determining whether the user is allowed access to the database object according to security rules, the access control document and GRANT parameters;
d. if not, rejecting the access to the database object;
e. if so, granting access to the database object.

10. The computer program product of claim 9 wherein the method further includes the steps of receiving the requesting user's ID and examining the requesting user's ID against the access control document and GRANT parameters to determine whether the requesting user can obtain access to the database object.

11. The computer program product of claim 10 wherein the GRANT parameters include the timeframe in which the requesting user can obtain access to the database object.

12. The computer program product of claim 11 wherein the GRANT parameters include timestamps.

13. The computer program product of claim 10 wherein the GRANT parameters include the timeframe in which the requesting user cannot obtain access to the database object.

14. The computer program product of claim 10 wherein the GRANT parameters include timestamps.

15. The computer program product of claim 10 wherein the GRANT parameters are stored in a database table.

16. The computer program product of claim 10 wherein the method further includes the step of a database administrator changing the GRANT parameters.

17. A method for granting access to a database comprising the steps of:
a. providing a grant statement capability for the database, the grant statement having a time limitation or access flag value parameter;
b. setting the parameter to a time limitation or SQL statement operator value in a first grant statement and requesting authority with the first grant statement;
c. providing access to the requesting authority for the time limitation or the operator value; and
d. removing the access to the requesting authority.

18. A system, having database objects, for determining whether access should be granted to a database object in the system, the system having an access control document for the database object, the access control document having access GRANT parameters for the database object, comprising:
a. a transmitter/receiver for receiver requests for access to data objects from users and for receiving their user IDs and for transmitting the data objects or data access rejections;
b. a parser for parsing the requests and the user IDs;
c. an examiner for examining the parsed requests and user IDs;
d. a determiner for pulling a GRANT access document and determining whether the parsed request should be granted based upon the examination of the access request and user ID against the GRANT access document; and
e. a database for storing the database object.

19. The system of claim 18 further comprising an updater to update the GRANT access document.
